(19) United States
(12) Patent Application Publication
(10) Pub. No.: US 2011/0131760 A1
(43) Pub. Date: Jun. 9, 2011

(54) HINGE

(75) Inventor: WEN-BIN SHEN, Tu-Cheng (TW)

(73) Assignee: HON HAI PRECISION INDUSTRY CO., LTD., Tu-Cheng (TW)

(21) Appl. No.: 12/644,018

(22) Filed: Dec. 22, 2009

(30) Foreign Application Priority Data
Dec. 9, 2009 (CN) 200920316878.0

(51) Int. Cl. E05D 11/10; E05D 3/06

(52) U.S. Cl. 16/346; 16/319

(57) ABSTRACT

A hinge includes a fixing member, a shaft unrotatably fixed to the fixing member, two rotating members, two shaft sleeves, and a connecting member. The shaft includes a shaft rod, with the two rotating members and two shaft sleeves rotatably mounted to the shaft rod. The shaft sleeves are unrotatably fixed to the rotating members, correspondingly, and located between the rotating members. The connecting member is fixed to the rotating members.

### BACKGROUND

1. Technical Field

The disclosure relates to a hinge.

2. Description of Related Art

A collapsible device, such as a notebook computer or a clamshell mobile phone, generally includes a main body and a display hinged to the main body. The hinge allows the display to be rotatable with respect to the main body, and to be folded with the main body for saving space.

A hinge normally includes a first element fixed to the main body, a shaft fixed to the first element, and a second element fixed to the display. The second element includes a generally C-shaped sleeve portion elastically sleeved on the shaft. During rotation of the display, the second element rotates with respect to the first element, together with the sleeve portion around the shaft, and during this, the sleeve portion is resiliently deformed. When rotation of the display stops, the sleeve portion rebounds to maintain the display at a desired angle, which can vibrate the display and possibly damaging the collapsible device.

### BRIEF DESCRIPTION OF THE DRAWINGS

FIG. 1 is an exploded, isometric view of an exemplary embodiment of a hinge.

FIG. 2 is similar to FIG. 1, but viewed from another perspective.

FIG. 3 is an assembled, isometric view of the hinge of FIG. 1.

### DETAILED DESCRIPTION

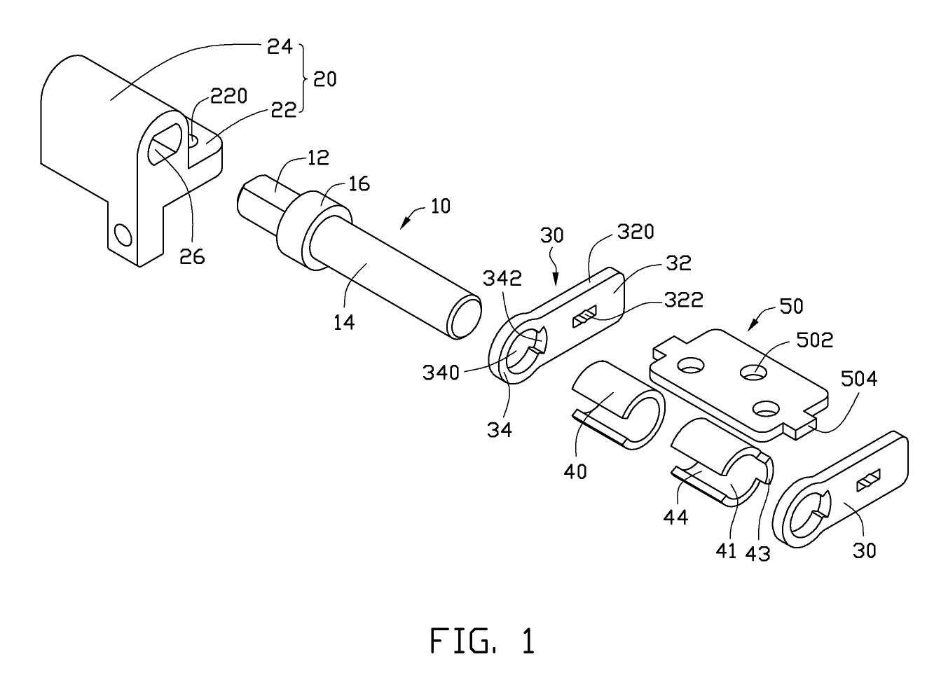

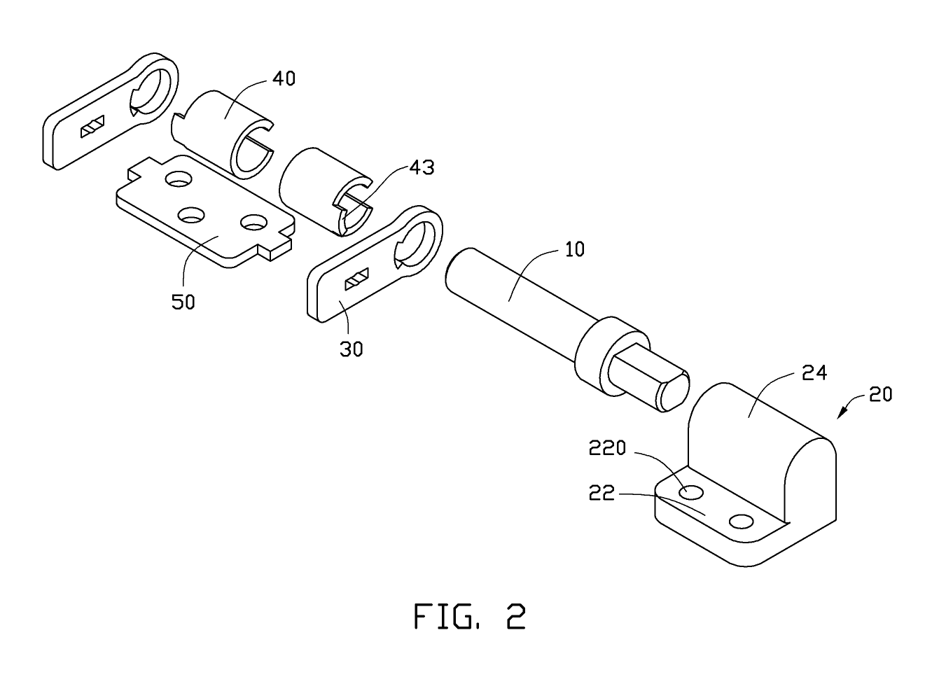

Referring to FIGS. 1 and 2, an exemplary embodiment of a hinge includes a shaft 10, a fixing member 20, two rotating members 30, two shaft sleeves 40, and a connecting member 50 fixedly mounted to the two rotating members 30.

The shaft 10 includes a fixing portion 12 having a D-shaped cross-section, a shaft rod 14 opposite to the fixing portion 12, and a washer-shaped resisting portion 16 between the fixing portion 12 and the shaft rod 14. The shaft rod 14 and the resisting portion 16 each have a circular cross-section, and the resisting portion 16 has a greater diameter than the shaft rod 14.

The fixing member 20 includes a connecting portion 22 defining a plurality of fixing holes 220 therein, and a fixing portion 24 perpendicularly extending from a side of the connecting portion 22. The fixing portion 24 axially defines a fixing hole 26 having a double-D shaped cross-section, corresponding to the fixing portion 12 of the shaft 10, for unrotatably fixing the shaft 10 to the fixing member 20.

Each rotating member 30 is longitudinally planar, and includes a fixing arm 32, and a pivoting portion 34 extending from an end of the fixing arm 32. The fixing arm 32 includes two opposite sidewalls 320. An oblong-shaped matching hole 322 is defined in the fixing arm 32 between the sidewalls 320. The pivoting portion 34 defines a pivot hole 340, through which the shaft rod 14 of the shaft 10 is freely extended. A locking hole 342 is defined in the pivoting portion 34, communicating with and located beside the pivot hole 340.

Each shaft sleeve 40, having a generally C-shaped cross-section, axially defines a receiving hole 41 therein, thereby the shaft rod 14 of the shaft 10 may rotate freely relative to the shaft sleeve 40. A cutout 44 is axially defined in the shaft sleeve 40 extending through two opposite ends of the shaft sleeve 40, thereby the shaft sleeve 40 is deformable. The cutout 44 communicates with the receiving hole 41. A fixing post 43 axially extends from one end of the shaft sleeve 40, opposite to the cutout 44.

The connecting member 50 is generally board-shaped, and a plurality of fixing holes 502 are defined in the connecting member 50. Two fixing blocks 504 extend from opposite ends of the connecting member 50.

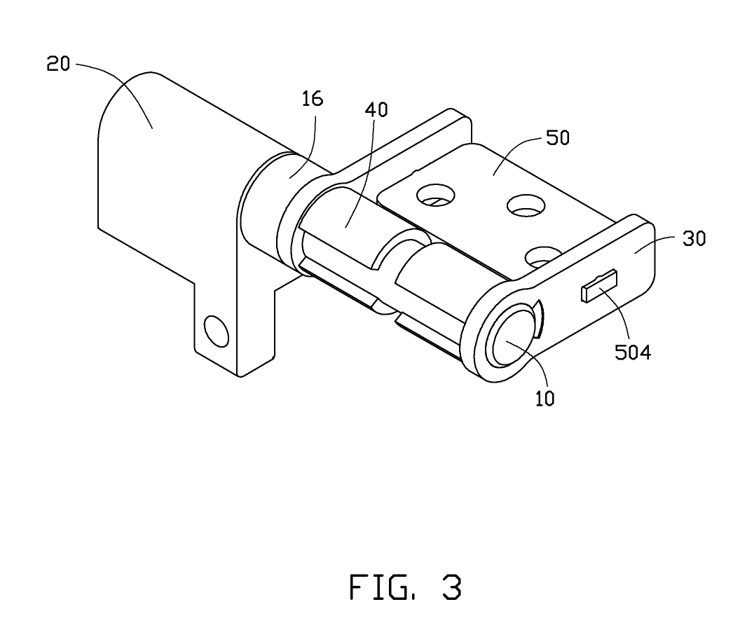

Referring to FIG. 3, in assembly, the fixing portion 12 of the shaft 10 is fixedly received in the fixing hole 26 of the fixing member 20, thereby, the shaft 10 is unrotatably fixed to the fixing member 20. The shaft rod 14 of the shaft 10 is rotatably extended through the pivot hole 340 of one of the rotating members 30, the receiving holes 41 of the shaft sleeves 40, and the pivot hole 340 of the other one of the rotating members 30 in that order.

In the aforementioned assembly, the proximal rotating member 30 resists against the resisting portion 16 of the shaft 10. The fixing post 43 of each shaft sleeve 40 is fixed in the locking hole 342 of an adjacent rotating member 30, such that the shaft sleeves 40 are unrotatably fixed to and rotated together with the corresponding rotating members 30. In this scenario, the shaft sleeves 40 are located between the pivoting portions 34 of the rotating members 30, and the fixing arms 32 of the rotating members 30 are opposite to each other. The fixing blocks 504 of the connecting member 50 are fixedly engaged in the matching holes 342 of the rotating members 30, correspondingly. As a result, the connecting member 50 is sandwiched between the fixing arms 32, and the opposite ends of the connecting member 50 firmly resist against the fixing arms 30, correspondingly.

In another embodiment, the aforementioned hinge further includes a fastener (not shown) fixed to a distal end of the shaft 10, or the distal end of the shaft rod 14 of the shaft 10 may be riveted to the outmost rotating member 30, for preventing the fixing member 20, the rotating members 30, and the shaft sleeves 40 from disengaging from the shaft rod 14 of the shaft 10.

In use, the above-mentioned hinge can be utilized in a collapsible device, such as a notebook computer, that includes a base and a cover hinged to the base. The fixing member 20 is fixed to the cover via the plurality of fixing holes 220. Therefore, the cover is also supported by the corresponding sidewalls 320 of the fixing arms 32 of the rotating members 30. Correspondingly, the connecting member 50 is fixed to the base via the plurality of fixing holes 502. Therefore, during rotation of the cover relative to the base, the rotating members 30 together with the shaft sleeves 40 rotate relative to the fixing member 20. In this process, the shaft sleeves 40 are elastically clamped around a circumference of the shaft rod 14 of the shaft 10. When the cover stops rotating, the shaft sleeves 40 simultaneously stop, reducing deformation of the shaft sleeves 40 thus reducing rebounding.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

What is claimed is:

1. A hinge comprising:
a fixing member;
a shaft unrotatably fixed to the fixing member, the shaft comprising a shaft rod;
two rotating members rotatably mounted to the shaft rod;
two shaft sleeves unrotatably fixed to the rotating members, respectively, the shaft sleeves rotatably mounted to the shaft rod, and located between the rotating members; and
a connecting member fixed to the rotating members.

2. The hinge of claim 1, wherein each shaft sleeve has a generally C-shaped cross-section, and axially defines a receiving hole for the shaft rod extending therethrough, and a cutout communicating with the receiving hole for the shaft sleeve being deformable.

3. The hinge of claim 2, wherein each rotating member defines a matching hole, a fixing post axially extends from one end of each shaft sleeve, to engage in the matching hole.

4. The hinge of claim 1, wherein each rotating member includes a fixing arm and a pivoting portion beside the fixing arm, the shaft sleeves are aligned between the pivoting portions, and the connecting member is sandwiched between the fixing arms.

5. The hinge of claim 4, wherein each fixing arm defines a matching hole, two fixing blocks extend from opposite ends of the connecting member, the fixing blocks are fixedly engaged in the matching holes of the fixing arms, and the opposite ends of the connecting member resist against the corresponding fixing arms.

6. The hinge of claim 4, wherein each pivoting portion defines a pivot hole, each shaft sleeve axially defines a receiving hole aligned with the corresponding pivot hole, the shaft rod is freely extended through the pivot hole of one of the rotating member, the receiving holes of the shaft sleeves, and the pivot hole of the other rotating member in that order.

7. The hinge of claim 6, wherein each pivoting portion further defines a locking hole communicating with and located beside the pivot hole, a fixing post axially extends from one end of each shaft sleeve, to engage in the locking hole.

8. The hinge of claim 7, wherein each shaft sleeve further axially defines a cutout communicating with the receiving hole, for the shaft sleeve being deformable.

9. The hinge of claim 1, wherein each rotating member defines a pivot hole, for the shaft rod extending therethrough.

10. The hinge of claim 9, wherein each rotating member further comprises a locking hole communicating with and located beside the pivot hole, a fixing post axially extends from one end of each shaft sleeve, to engage in the matching hole.

11. The hinge of claim 10, wherein each shaft sleeve has a generally C-shaped cross-section, and axially defines a receiving hole for the shaft rod extending therethrough.

12. The hinge of claim 11, wherein each shaft sleeve further axially defines a cutout communicating with the receiving hole, for the shaft sleeve being deformable.
